(19) United States
(12) Patent Application Publication
(10) Pub. No.: US 2015/0254613 A1
(43) Pub. Date: Sep. 10, 2015

(54) CLOSED LOOP REFRIGERANT RECYCLING METHOD

(71) Applicant: EOS CLIMATE, San Francisco, CA (US)

(72) Inventor: Joseph MADDEN, San Francisco, CA (US)

(21) Appl. No.: 14/621,600

(22) Filed: Feb. 13, 2015

Related U.S. Application Data
(60) Provisional application No. 61/947,823, filed on Mar. 4, 2014.

(51) Int. Cl. G06Q 10/00; G06Q 30/02

(52) U.S. Cl. CPC G06Q 10/30; G06Q 30/0238

(57) ABSTRACT

A central recycling system manages refrigerant recycling by storing parameters describing a financial contribution from at least one participating entity to an incentive fund, receiving data about a used refrigerant-based appliance surrendered by a consumer, receiving data about disassembly of the used refrigerant-based appliance including recovery of refrigerant, receiving data about a recycling process applied to the recovered refrigerant, and determining a point of sale value associated with recycling the used refrigerant-based appliance based on the received data and the stored parameters. The recycling includes at least one of reclaiming and destroying the recovered refrigerant.

### FIELD OF THE INVENTION

The embodiments of the invention relate in general to methods and systems for effectively managing, monitoring, and providing incentives for recycling of refrigerants in multiple programs controlled through a centralized recycling system.

### BACKGROUND

Refrigerants have been widely used throughout the world, in homes, offices, and factories, in devices such as refrigerators, air conditioners, central air conditioning systems (HVAC), freezers, and dehumidifiers. In particular, residential refrigerant-based appliances are typically substantial users of electricity, with older units consuming significantly more energy than the newer ones. Since refrigerant-based appliances have a long shelf life, they are often not replaced until they fail. Depending on their year of manufacture, older refrigerant-based appliances may contain ozone-depleting refrigerants (ODRs). In addition to depleting the ozone layer, these substances are also potent greenhouse gases (GHGs) when emitted to the atmosphere. While the refrigerants used in newly manufactured units do not contain ODRs they are still strong GHGs. Therefore, to reduce energy demand, ozone depletion, and global climate impacts, older units need to be permanently removed from the energy grid and properly demanufactured of so that refrigerant substances may be recovered and either recycled or destroyed.

While entities with various interests in refrigerant recycling, for example, governments, manufacturers, utilities, etc. may provide appliance disposal programs that involve consumer incentives, such programs are separately deployed and may create a complex landscape for a consumer to select an appropriate program. A system is needed that integrates the different consumer benefits for the various entities while still allowing them to promote their own program agendas, goals and relationships with consumers.

### SUMMARY

The various embodiments provide a method for managing refrigerant recycling including: storing parameters describing a financial contribution from at least one participating entity to an incentive fund, receiving data about a used refrigerant-based appliance surrendered by a consumer, receiving data about disassembly of the used refrigerant-based appliance including recovery of refrigerant, receiving data about a recycling process applied to the recovered refrigerant, and determining a point of sale value associated with recycling the used refrigerant-based appliance based on the received data and the stored parameters. In the embodiments, the recycling process includes at least one of reclaiming and destroying the recovered refrigerant.

Other embodiments provide a method for limiting use of energy-inefficient appliances including: storing parameters describing a financial contribution from at least one participating entity to an incentive fund; receiving data about an energy-inefficient appliance surrendered by a consumer; receiving data about disassembly of the energy-inefficient appliance; receiving data about manufacture of one or more energy-efficient replacement appliance that performs similar functions to the energy-inefficient appliance; and determining a point of sale value based on the received data and stored parameters, in which the point of sale value is associated with a representative amount of energy that would be consumed by the energy-inefficient appliance in excess of a representative amount of energy consumed by the one or more energy-efficient replacement appliance.

Other embodiments provide a method for promoting use of energy-efficient appliances including: storing parameters describing a financial contribution from at least one participating entity to an incentive fund; receiving data about a purchase of a new refrigerant-based appliance by a consumer; receiving data about manufacture of the new refrigerant-based appliance purchased by the consumer; determining whether the new refrigerant-based appliance contains refrigerant that has been recycled through at least one reclamation process; determining a point of sale value based on the received data and stored parameters in response to determining that the new refrigerant-based appliance contains refrigerant that has been recycled through at least one reclamation process; and providing compensation to at least one of the consumer, a manufacturer, and a retailer based on the determined point of sale value.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 illustrates a schematic diagram of a centralized recycling system according to an embodiment.

FIG. 2 is a process flow diagram illustrating a method for managing refrigerant recycling and destruction in a centralized recycling system according to an embodiment.

FIG. 3 is a component block diagram of a laptop computer suitable for implementing the various embodiment methods.

FIG. 4 is a component block diagram of a server suitable for implementing the various embodiment methods.

FIG. 5 is a component block diagram of a mobile computing device suitable for implementing the various embodiment methods.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, “refrigerant, “ozone depleting refrigerant” and “ODR” may be used interchangeably to refer to substances that are used to chill air in various appliances, such as in refrigerators, freezers, air conditioners and heating, ventilating and air conditioning units (HVAC). Different types of refrigerant gases include chlorofluorocarbon (CFC), hydrochlorofluorocarbon (HCFC), hydrofluorocarbon (HFC), perfluorocarbon (PFC), and blends made from ammonia and carbon dioxide.

As used herein, “green house gas” or “GHG” refers to a gas in the atmosphere that absorbs and emits radiation within the thermal infrared range, thereby contributing to the greenhouse effect.

As used herein, “reclamation” refers to reprocessing and upgrading of a recovered refrigerant using techniques such as filtering, drying, distillation and/or chemical treatment in order to restore the substance to a specified standard of purity.

Given the large number of systems that use refrigerant substances (“refrigerant-based appliances”) taken out of service each year, the environmental impacts of removing and properly disposing of component materials significantly furthers a multitude of environmental interests. Such interests may include, for example, preventing emissions of ozone depleting substances (ODSs) and greenhouse gases (GHGs) by avoiding their release from refrigerants, saving landfill space and energy by recycling durable components, and reducing energy consumption by replacing old technology with energy efficient alternatives.

In many countries, strict guidelines now exist for the installation, repair, recovery and recycling of refrigerants. Such regulation is provided in the United States, by the Environmental Protection Agency (EPA) and Clean Air Act. In particular, when refrigerant-based appliances are taken out of service, federal law prohibits the venting of any refrigerant gases into the atmosphere, and requires that all refrigerant be recovered prior to dismantling or disposal of the appliance. However, in order for used refrigerant to be sold, it must first be reclaimed by an EPA-certified refrigerant reclaimer. Various state and local governments may impose additional requirements for refrigerant recycling.

Typically, old refrigerant-based appliances are disposed by consumers through curbside pick-up programs offered by local governments or through appliance pick-up services offered by retailers when a new unit is purchased and delivered. Some of the units may be re-sold domestically or abroad by subcontracted third parties. Thus, in some cases inefficient refrigerant-based appliances may be introduced back onto the domestic electricity grid, or may be provided to developing countries that are less likely to provide responsible handling of refrigerant at end-of-life. Other refrigerant-based appliances surrendered by consumers that are not in sufficient condition for resale may typically be dismantled into component parts, including recovery of refrigerant therein. While federal regulations govern the treatment of the refrigerants in such appliances, compliance may be unverified.

Thus, while many interests are at play for recycling of refrigerants, as well as a number of legal requirements, the applicable regulatory schemes may effectively render the most environmentally positive approaches to be the most difficult, costly or challenging, particularly for an individual consumer. Various programs have been deployed by public and private entities and/or partnerships to alleviate some of these issues. For example, bounty-based appliance turn in programs offer financial incentives, such as a direct gift, or rebate or discount toward the purchase of an energy efficient model (e.g., ENERGY STAR® qualified appliances). However, different appliance bounty programs have specifications for the appliances they can accept. Further, the other programs that are typically sponsored by various interested entities are separately implemented, since each entity generally has a slightly different overall goal than each other entity.

Therefore, the various embodiments provide methods and systems for managing refrigerant gases through a centralized recycling system that coordinates individual interests of multiple sponsoring entities, and provides a single collective incentive for each consumer transaction. Refrigerant gases in refrigerant-based appliances that may be managed in to some embodiments may include ODRs (which may create ODSs, for example, halons, CFCs, hydrochlorofluorocarbons (HCFCs), etc.). In other embodiments, the managed refrigerant gases may include any substance commonly used in the heat cycle of a refrigeration system (e.g., hydrofluorocarbons (HFCs), perfluorocarbons (PFCs), hydrocarbons, ammonia, etc.).

In various embodiments, sponsoring entities are entities that sponsor take-back programs for appliances that use refrigerant gases (e.g., refrigerators, HVACs, etc.). Such entities may include, but are not limited to, original equipment manufacturers (OEMs), retailers, utility companies, and local, state and/or federal government agencies. The various embodiments provide an incentive fund that is managed by a custodian, to which participating entities may contribute. While participating entities may provide financial sponsorship based on their specific program needs, the centralized recycling system provides efficiencies by consolidating and coordinating their assets. Further, the management of the incentive fund by the custodian allows multiple program incentives and/or conditions offered by unrelated entities to be input into determining a metric for a single point of sale (i.e., price, rebate, etc.).

In addition to the management of the incentive fund, the custodian may track and store data relating to the various transactions in the centralized recycling system. Further, in some embodiments the custodian may additionally or alternatively track refrigerant gas units over their lifecycle for verification and/or certification purposes relating to the surrendering refrigerant-based appliances, and reclaiming and/or destroying the refrigerant. In an embodiment, the lifecycle of a refrigerant unit may be tracked among multiple entities, for example from its distribution to a user to destruction (or reclamation and reuse) for comprehensive data of its environmental impact, which may then be applied as a factor in determining a point of sale value (e.g., a rebate amount, discount in purchase of a new appliance, etc.). Additionally or alternatively, the comprehensive data may provide necessary verifications that are required as a condition of receiving the financial incentive provided by a particular participating entity.

In order to enable such tracking functions, the custodian may establish relationships with any one or more of consumers, retailers, remanufacturers, certified reclaimers and/or destruction facilities, and OEMs.

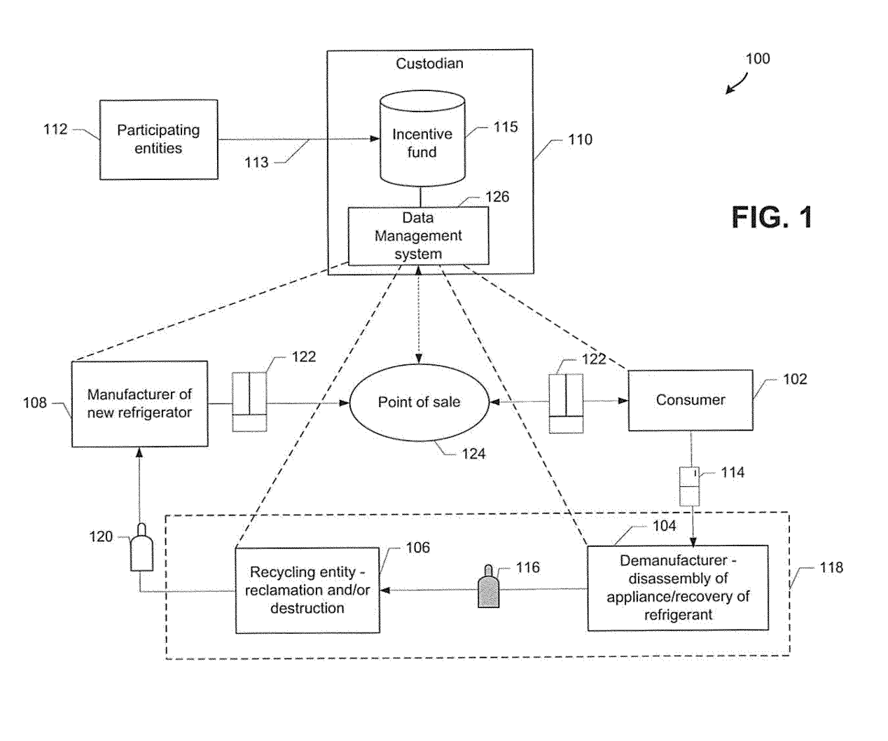

FIG. 1 illustrates the operation of an example centralized recycling system. In an embodiment, the centralized recycling system may include the exchange of funds and information, and/or the transfer of refrigerant-based appliances and refrigerant gas units, across multiple entities that may or may not be under common control. For example, the centralized recycling system 100 may track exchange of funds, information and/or appliances/refrigerants between entities such as a consumer 102 of refrigerant-based appliances, a demanufacturer 104, a recycling entity 106, and a refrigerant-based appliance manufacturer 108, any two or more of which may be replaced by one or more entities performing analogous functions. Coordination of the of functions such entities may be performed by a custodian 110 and based on an incentive fund 115, which is discussed in further detail below. The solid lines in the centralized recycling system 100 illustrate flows of physical items or funds, while the dashed lines illustrate the exchange of information.

In various embodiments, used refrigerant-based appliances 114 that contain end-of-life refrigerant may be transported from a consumer 102 to a demanufacturer 104 be disassembled into component parts, including used refrigerant, from the refrigerant-based appliance. In various embodiments, the transport of the used refrigerant-based appliances 114 to the demanufacturer 104 from the consumer 102 may be performed by a logistics provider (not shown) for example, a third party delivery service. In other embodiments, the transport may be performed directly by either the consumer 102 or demanufacturer 104.

The demanufacturer 104 may disassemble the used appliance, remove the used refrigerant, and transfer to a recycling entity 106 the used refrigerant 116 recovered from disassembly of the refrigerant-based appliance. The recycling entity 106 may recycle the used refrigerant by reclaiming clean refrigerant or by destroying the used refrigerant. Optionally, the recycling entity 106 and demanufacturer 104 may be part of a single entity 118. In various embodiments, the recycling entity 106 may be an EPA certified reclaimer or approved destruction facility, while in other embodiments the recycling entity 106 may employ some degree of third party contracting to recycle the recovered refrigerant (not shown). In an embodiment in which the recycling entity 106 reclaims clean refrigerant for reuse, or employs a third party for such action, the recycling entity 106 may provide the reclaimed clean refrigerant 120 to one or more manufacturers 108, who may in turn utilize the reclaimed clean refrigerant 120 in the production of new refrigerant-based appliances 122. While manufacturer 108 is shown as one entity, it may represent be one or more of a variety of different manufacturing entities that work together to bring products from manufacture to sale.

The new refrigerant-based appliances that are manufactured with recycled refrigerant may be transferred to a retailer 124 for various points of sale values and transactions.

As mentioned above, throughout these steps, data may be collected by the custodian 110 for use in conjunction with an incentive fund 115.

In particular, participating entities 112 may provide financial contributions 113 to an incentive fund 115. The participating entities 112 may be various public and/or private sector interests, each of which may participate according to terms of its own unique program. For example, a first participating entity, such as a government agency, may provide monetary contributions based on federal or state funds specifically allocated for such purpose, whereas a second participating entity (e.g., an OEM or retailer) may tie its contribution to a measure of the new refrigerant-based appliances containing recycled refrigerant that it made or sold over a certain time interval. For example, the second participating entity may contribute a percentage of the revenue realized from sales of these new refrigerant-based appliances over the past year. Any of a number of other methods of contributions by participating entities may be employed as alternatives or in addition to these examples.

The incentive fund 115 may be managed by a custodian 110 (e.g., a corporate or government entity), which may maintain contribution records, statements, and/or related information in suitable data structures for storage on any of a number of storage media types. The custodian 110 may use a data management system 126 in communication with the retailer, consumer, demanufacturer, recycling entity, and manufacturer. In various embodiments, the data management system 126 may integrate information from the incentive fund 115 with relevant data from other exchanges and transfers of the centralized recycling system 100 to provide one or more point of sale values. The data management system 126 may therefore enable consumers 102 to realize financial and/or other benefits from the incentive fund based on the values derived at their particular points of sale.

In an example use of the centralized recycling system 100, a consumer 102 may dispose of an old refrigerant-based appliance through a transaction in which the appliance is provided to a demanufacturer 104 (e.g., via transport by a logistics provider). The data management system 126 of the custodian 110 may collect various data about this transaction. Such data may include, without limitation, information about the old appliance (i.e., type of appliance, year of manufacture, brand, type of refrigerant used, etc.), information about the transacting parties (e.g., geographic location, identity of the demanufacturer, consumer name and type (i.e., residential or commercial), etc.). Subsequently, as the used refrigerant extracted from the appliance is passed to a recycling entity 106 for destruction or reclamation, the data management system 126 may collect additional data. Such data may include, without limitation, the identity of the demanufacturer and recycling entity, payment for used refrigerant, composition of used refrigerant, whether the refrigerant will be reclaimed or destroyed, verification of EPA certification if it is to be reclaimed, identification of the technology to be used if it is to be destroyed, any special ratings given to or the recycling entity, etc.

For reclaimed refrigerant, as the reclaimed refrigerant is passed to one or more manufacturer 108 for use in filling new refrigerant-based appliances, the data management system 126 may capture information including, without limitation, information about the recycling entity and the manufacturer (e.g., identity, location, role in manufacturing and/or retail chain, etc.), information about the transacting parties, etc. (e.g., type, brand and/or number of new refrigerant-based appliances filled using the recycled refrigerant from that old appliance, amount of new or reclaimed refrigerant, composition of new or reclaimed refrigerant, etc.). The data management system 126 may also track the transfer of the new refrigerant-based appliances 122 that are filled with recycled refrigerant with recycled refrigerant from the manufacturer 108 to the point of sale 124 (i.e., a retailer).

In the various embodiments, the data management system 126 may use the collected data and the various reward programs and conditions associated with programs run by participating entities 112 to arrive at a point of sale value. Specifically, the data management system 126 may execute one or more benefit calculation functions on input parameters including the collected data and information from the incentive fund.

The resulting point of sale value may be realized as any of a number of monetary benefits to the consumer 102 and/or to the demanufacturer 104, recycling entity 106, manufacturer 108 and retailer at point of sale 124. For example, a resulting point of sale value may be in the form of a discount ticket/coupon/code that entitles the customer to a specific reduction in price for a purchase of an energy efficient refrigerant-based appliance (e.g., one of the new refrigerant-based appliances made by manufacturer 108), based on the surrender of the used refrigerant-based appliance to the demanufacturer 104.

In other embodiments, the consumer 102 may choose purchase a new refrigerant-based appliance either prior to or close in time to the disposal of the old appliance. In such embodiments, the data management system 126 may also collect various data about this transaction between the consumer 102 and a manufacturer 108 (directly or via a retailer at the point of sale 124). The manufacturer 108 may represent one or more manufacturers, as well as one or more retailers. The data collected by the data management system 126 may include, without limitation, information about the new appliance (i.e., type of appliance, year of manufacture, brand, any energy certification, type of refrigerant used, etc.), information about the transacting parties (e.g., geographic location, identity of the retailer, consumer type (i.e., residential or commercial), etc.). The data about this transaction may be added to the information to be used as input parameters to arrive at the point of sale value determination. In this variation, since the consumer 102 will have completed both the purchase of a new and disposal of an old appliance prior to performance of the benefit calculation by the data management system 126, in this variation, the consumer 102 may be rewarded by direct compensation (e.g., mailing a check to the consumer, transferring funds into an account, etc.) or rebate (e.g., mail-in rebate or electronic rebate) as opposed to receiving a direct discount at the time of purchasing the new refrigerant-based appliance. Thus, point of sale values realized by consumers in various embodiments may occur in transactions that are independent from the actual point-of-sale (i.e., purchase of a new refrigerant-based appliance). In other words, every new refrigerant-based appliance sale may get a code that the data management system 126 turns into a rebate when the consumer 102 surrenders the used refrigerant-based appliance 114 to the demanufacturer 104.

In alternative embodiments, the centralized recycling system 100 may also enable point of sale values to be realized by consumers based on surrender of any energy-inefficient appliances, whether or not refrigerant based. In such embodiments (not shown), based on the amount of energy saved by an energy-inefficient appliance being permanently taken off of the electricity grid rather than resold or reused, a consumer may receive a point of sale value, such as a rebate or other incentive, to purchase an energy-efficient replacement appliance. In an example, a consumer 102 may surrender an energy-inefficient appliance in a transaction with a demanufacturer 104 (e.g., via transport by a logistics provider). The data management system 126 of the custodian 110 may collect various data about this transaction. Such data may include, without limitation, information about the old, energy-inefficient appliance (i.e., type of appliance, year of manufacture, brand, materials contained in the appliance, etc.), information about the transacting parties (e.g., geographic location, identity of the demanufacturer, consumer name and type (i.e., residential or commercial), etc.). The demanufacturer 104 may then disassemble the energy-inefficient appliance into component parts and proceed to safely dispose of and/or recycle various materials, depending on protocols established for the specific appliance. The data management system 126 may collect additional data verifying the disassembly, and therefore permanent removal of the energy-inefficient appliance from the power grid.

In various embodiments, the one or more benefit calculation functions executed by the data management system 126 may be designed to implement a number of multi-variable data processing techniques known to those of ordinary skill in the art. In some embodiments the custodian 110 and/or participating entities 112 may be part of a team to create customized functions according to centralized recycling system goals and/or logistics. In some embodiments, the one or more benefit calculation functions may involve applying various weights to the different data items in order to arrive at the point of sale value. Such weights may be based on any number of criteria, which may be used individually or in collection for adjusting the affect of parameters in the benefit calculation functions. As an example, in a geographic location that has an abnormally high level of reliance on the electricity grid, parameters about the old refrigerant-based appliance may be weighted such that energy use of the appliance (i.e., determined by consumer's identification of type/brand) has a much larger affect on point-of-sale value ultimately arrived by the one or more benefit calculation functions.

The data management system 126 may also enable life cycle tracking of a refrigerant starting from its use in manufacturing a new refrigerant-based appliance, through end of life destruction or further reclamation. This life cycle tracking may be used by the data management system 126 to generate further parameters for input into the one or more benefit calculation functions. For example, a consumer's disposal of an old refrigerant-based appliance for which the data management system 126 has a complete life cycle record and/or can verify a previous reclamation cycle may result in a higher ultimate point-of-sale value based the additional parameters input into the one or more benefit calculation function.

In the various embodiments, the data management system 126 of the custodian 110 may also include of a number of known types of devices, including, but not limited to, a desktop personal computing device, a notebook/laptop personal computing device, a mobile computing device, and a computer server. In another embodiment, the data management system 126 may be one of multiple central management devices that form the central management system. In another embodiment, the data management system 126 may be a remote system configured to collect various data and to track refrigerant units and/or refrigerant-based appliances to a separate central management system. Additionally, such remote system may be configured to retrieve data and/or tracking information that may already be stored on the separate central management system, and to download and/or display the retrieved information to a user of remote system. The exchange of information between the remote system and the separate central management system may be performed using any of the various data communication protocols known in the art. In another embodiment, the data management system 126 may be a server operated by a third party (for example, EOS Climate, Inc.) or by one or more of a demanufacturer 104 and/or recycling entity 106.

The entities involved in the centralized recycling system 100 of the various embodiments may be replaced by one or more entities performing analogous functions.

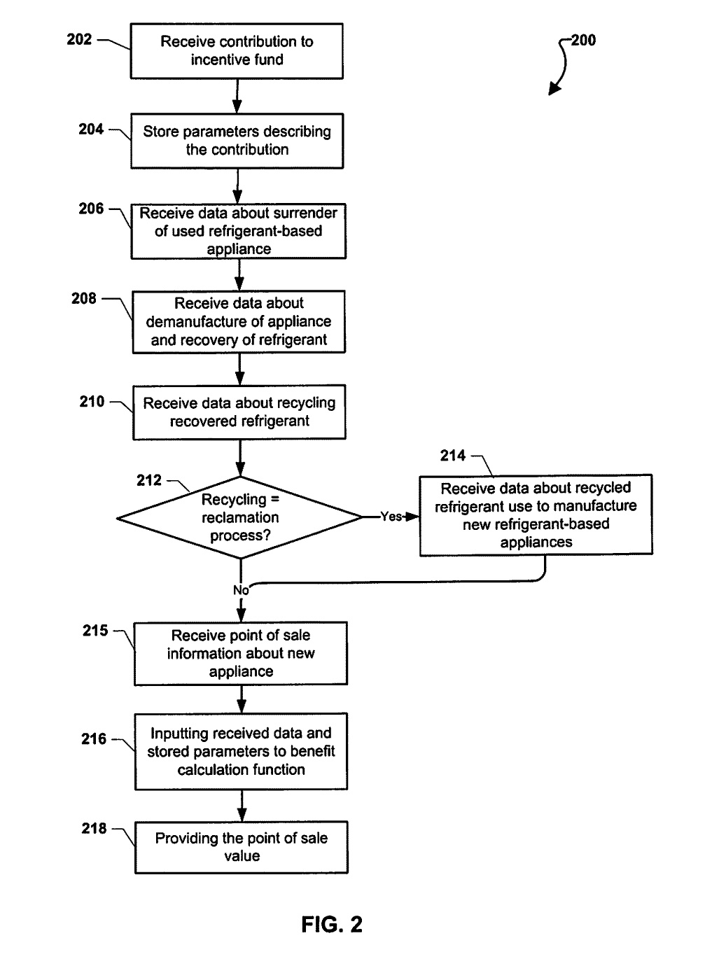

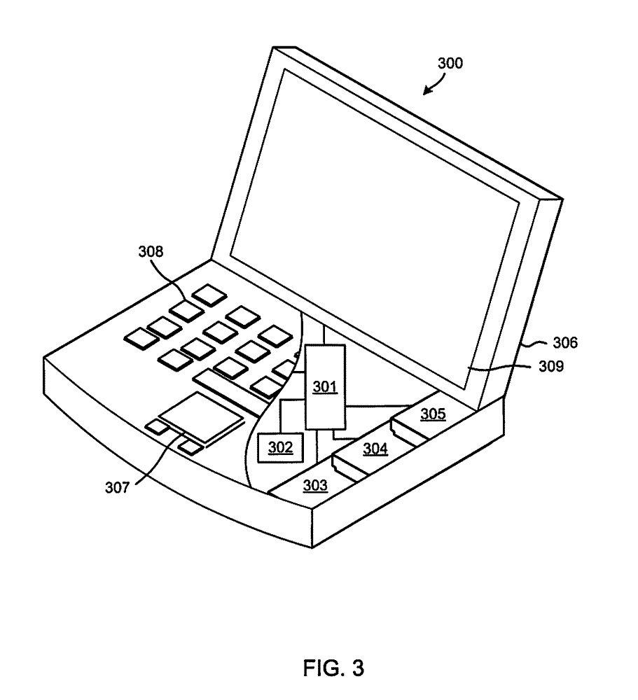

FIG. 2 illustrates a method 200 of managing multiple refrigerant recycling and destruction interests by implementing a centralized recycling system. The operations of method 200 may be implemented by one or processor of the data management system 126, examples of which are discussed below with respect to FIGS. 3-5.

In block 202, the data management system processor may receive or note a contribution by a participating entity 112 into the incentive fund 115. In block 204, the data management system processor may store parameters describing the contribution (e.g., entity, payment type, program metrics, etc.). In block 206, the data management system processor may receive data about a customer's 102 surrender of a refrigerant-based appliance 114 to a demanufacturer 104. In block 208, the data management system processor may receive data about the demanufacture of the appliance 114 and about the recovery of its refrigerant by the demanufacturer 104. In block 210, the data management system processor may receive data about recycling the recovered refrigerant, such as by reclamation or destruction by a recycling entity 106. In determination block 212, the data management system processor may determine whether recycling the recovered refrigerant involved reclaiming the recovered refrigerant. If recycling the recovered refrigerant involved reclaiming the recovered refrigerant (i.e., determination block 212=“Yes”), in block 214 the data management system processor may receive data about the use of the recycled refrigerant to fill a new refrigerant-based appliance during manufacture by a manufacturer 108. In block 215, the data management system processor may receive information about the sale of new refrigerant-based appliances from one or more retailer at the point of sale 124. If recycling the recovered refrigerant did not involve reclaiming the recovered refrigerant (i.e., determination block 212=“No”), the data management system processor may proceed directly to block 215. In block 216 the data management system processor may input received data and stored parameters in to a benefit calculation function. In block 218, the data management system processor may provide a point-of-sale value to the consumer and/or the demanufacturer 104, recycling entity 106, manufacturer 108, and/or retailer at the point of sale 124.

As described above, the central management system and/or other systems configured to implement the methods of the various embodiments may comprise the data management system 126. In an example embodiment, the data management system 126 may be at least one notebook computer 300 illustrated in FIG. 3. Such a notebook computer 300 typically includes a housing 306 that contains a processor 301 coupled to volatile memory 302 and to a large capacity nonvolatile memory, such as a disk drive 303. The computer 300 may also include a floppy disc drive 304 and a compact disc (CD) drive 305 coupled to the processor 301. The computer housing 306 typically also includes a touchpad 307, keyboard 308, and the display 309.

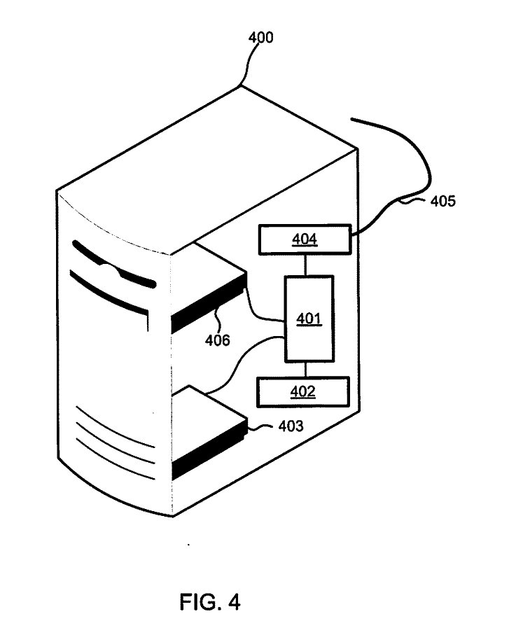

In another embodiment, data management system 126 may be at least one remote server device, such as the server 400 illustrated in FIG. 4. Such a server 400 typically includes a processor 401 coupled to volatile memory 402 and a large capacity nonvolatile memory, such as a disk drive 403. The server 400 may also include a floppy disc drive and/or a compact disc (CD) drive 406 coupled to the processor 401. The server 400 may also include a number of connector ports 404 coupled to the processor 401 for establishing data connections with network circuits 405.

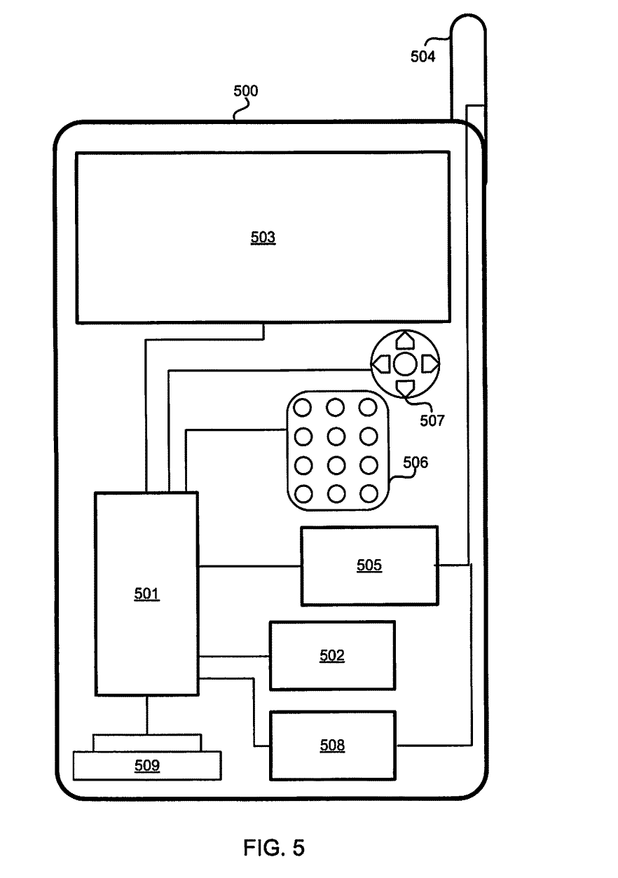

In another embodiment, data management system 126 may be at least one of a variety of mobile handsets, such as, for example, cellular telephones, personal data assistants (PDA) with cellular telephone, mobile electronic mail receivers, mobile web access devices, and other processor-equipped devices that may be developed in the future that connect to a wireless network. Typically, such mobile handsets will have in common the components illustrated in FIG. 5. For example, a mobile handset 500 may include a processor 501 coupled to internal memory 502 and a display 503. Additionally, the mobile handset 500 will have an antenna 504 for sending and receiving electromagnetic radiation that is connected to a wireless data link and/or cellular telephone transceiver 505 coupled to the processor 501. In some implementations, the transceiver 505 and portions of the processor 501 and memory 502 used for cellular telephone communications is referred to as the air interface since it provides a data interface via a wireless data link. Additionally, the mobile handset 500 will include a close range transceiver 508 capable of establishing and communicating a close range communication link, such as using one of the near field communication protocols. In some embodiments, the mobile handset 500 may include a scanner 509 (e.g., a barcode scanner) that may obtain optical image information, convert the information to digital data, and pass the data to the processor 501. Mobile handsets typically include a key pad 506 or miniature keyboard and menu selection buttons or rocker switches 507 for receiving user inputs.

The computing device processor 301, 401, 501 may be any programmable microprocessor, microcomputer or multiple processor chip or chips that can be configured by software instructions (applications) to perform a variety of functions, including the functions of the various embodiments described above. In some Central Processing Entities, multiple processors 301, 401, 501 may be provided, such as one processor dedicated to wireless communication functions and one processor dedicated to running other applications. The processor may also be included as part of a communication chipset.

The various embodiments may be implemented by a computer processor 301, 401, 501 executing software instructions configured to implement one or more of the described methods or processes. Such software instructions may be stored in memory 305, 402, 502, in hard disc memory 303, on tangible storage medium or on servers accessible via a network (not shown) as separate applications, or as compiled software implementing an embodiment method or process. Further, the software instructions may be stored on any form of tangible processor-readable memory, including: a random access memory 305, 402, 502, hard disc memory 303, a floppy disk (readable in a floppy disc drive 304), a compact disc (readable in a CD drive 305), electrically erasable/programmable read only memory (EEPROM), read only memory (such as FLASH memory), and/or a memory module (not shown) plugged into a central command server such as an external memory chip or USB-connectable external memory (e.g., a “flash drive”) plugged into a USB network port. For the purposes of this description, the term memory refers to all memory accessible by the processor 301, 401, 501 including memory within the processor 301, 401, 501 itself.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method for managing refrigerant recycling, comprising:
storing parameters describing a financial contribution from at least one participating entity to an incentive fund;
receiving data about a used refrigerant-based appliance surrendered by a consumer;
receiving data about disassembly of the used refrigerant-based appliance including recovery of refrigerant;
receiving data about a recycling process applied to the recovered refrigerant, wherein the recycling process comprises reclaiming or destroying the recovered refrigerant; and
determining a point of sale value associated with recycling the used refrigerant-based appliance based on the received data and the stored parameters.

2. The method of claim 1, further comprising:
determining whether the recycling process comprises reclaiming the recovered refrigerant; and
in response to determining that the recycling process comprises reclaiming the recovered refrigerant, receiving data about use of reclaimed refrigerant to manufacture new refrigerant-based appliances.

3. The method of claim 2, wherein determining a point of sale value is further based on the received data about use of reclaimed refrigerant.

4. The method of claim 1, further comprising providing a price reduction for the consumer to purchase an energy efficient refrigerant-based appliance based on the determined point of sale value.

5. The method of claim 1, further comprising providing financial compensation to one or more of a demanufacturer, recycling entity, manufacturer, and retailer based on the determined point of sale value.

6. The method of claim 1, further comprising:
receiving data about a purchase of a new refrigerant-based appliance by the consumer, wherein determining the point of sale value is further based on the received data; and
providing a rebate to the consumer for a portion of a price expended in the purchase of the new refrigerant-based appliance based on determining the point of sale value.

7. The method of claim 1, wherein the stored parameters describing the contribution from each of the at least one participating entity comprise an amount of the contribution, an identification of at least one source fund of the contribution, and any conditions or restrictions imposed by a specific program being implemented by the at least one participating entity.

8. A method for limiting use of energy-inefficient appliances, comprising:
storing parameters describing a financial contribution from at least one participating entity to an incentive fund;
receiving data about an energy-inefficient appliance surrendered by a consumer;
receiving data about disassembly of the energy-inefficient appliance;
receiving data about manufacture of one or more energy-efficient replacement appliance that performs similar functions to the energy-inefficient appliance; and
determining a point of sale value based on the received data and stored parameters, wherein the point of sale value is associated with a representative amount of energy that would be consumed by the energy-inefficient appliance in excess of a representative amount of energy consumed by the one or more energy-efficient replacement appliance.

9. The method of claim 8, further comprising providing a price reduction for the consumer to purchase one of the one or more energy-efficient replacement appliance based on the determined point of sale value.

10. A method for promoting use of energy-efficient appliances, comprising:
storing parameters describing a financial contribution from at least one participating entity to an incentive fund;
receiving data about a purchase of a new refrigerant-based appliance by a consumer;
receiving data about manufacture of the new refrigerant-based appliance purchased by the consumer;
determining whether the new refrigerant-based appliance contains refrigerant that has been recycled through at least one reclamation process;
determining a point of sale value based on the received data and stored parameters in response to determining that the new refrigerant-based appliance contains refrigerant that has been recycled through at least one reclamation process; and
providing compensation to at least one of the consumer, a manufacturer, and a retailer based on the determined point of sale value.
